(19) United States
(12) Patent Application Publication
(10) Pub. No.: US 2017/0158516 A1
(43) Pub. Date: Jun. 8, 2017

(54) FLUIDIZED-BED REACTOR AND PROCESS FOR PREPARING GRANULAR POLYCRYSTALLINE SILICON

(71) Applicant: Wacker Chemie AG, Munich (DE)

(72) Inventors: Simon PEDRON, Burghausen (IT); Bernhard BAUMANN, Emmerting (DE); Gerhard FORSTPOINTNER, Kastl (DE)

(73) Assignee: Wacker Chemie AG, Munich (DE)

(21) Appl. No.: 15/320,971

(22) PCT Filed: Jun. 19, 2015
(86) PCT No.: PCT/EP2015/063860

§ 371 Date: Dec. 21, 2016

(30) Foreign Application Priority Data
Jun. 24, 2014 (DE) 10 2014 212 049.7

(51) Int. Cl. C01B 33/03; C01B 33/029; B01J 8/18

(52) U.S. Cl. CPC C01B 33/03; B01J 8/1827; B01J 8/1836; B01J 8/1872; C01B 33/029; B01J 2208/00761; B01J 2208/00902

(57) ABSTRACT

A fluidized-bed reactor for preparing granular polycrystalline silicon has a reactor vessel, a reactor tube and a reactor bottom within the reactor vessel, and an intermediate jacket located between the reactor tube and the reactor vessel, a heating device, at least one bottom gas nozzle for introducing of fluidizing gas and at least one secondary gas nozzle for introducing reaction gas, a silicon seed particle feed, an offtake line for granular polycrystalline silicon and reactor offgas discharge, wherein a main element of the reactor tube comprises at least 60% by weight of silicon carbide with a CVD coating having a layer thickness of at least 5 μm and is at least 99.995% by weight of SiC, or a main element of the reactor tube is a sapphire glass comprising at least 99.99% by weight of α-Al₂O₃.

### CROSS REFERENCE TO RELATED APPLICATIONS

This application is the U.S. National Phase of PCT Appln. No. PCT/EP2015/063860 filed Jun. 19, 2015, which claims priority to German Application No. 10 2014 212 049.7 filed Jun. 24, 2014, the disclosures of which are incorporated in their entirety by reference herein.

### BACKGROUND OF THE INVENTION

Field of the Invention

1. The invention relates to a fluidized-bed reactor and a process for preparing granular polycrystalline silicon.

2. Description of the Related Art

Granular polycrystalline silicon is an alternative to polysilicon produced in the Siemens process. While the polysilicon is obtained in the Siemens process as a cylindrical silicon rod which has to be broken up in a time-consuming and costly operation to form chip poly and may have to be purified further before further processing, granular polycrystalline silicon has pourable properties and can be used directly as a raw material, e.g. for single crystal production for the photovoltaics and electronics industry.

Granular polycrystalline silicon is produced in a fluidized-bed reactor. This is effected by fluidizing silicon particles by means of a gas stream to give a fluidized bed, with this being heated to high temperatures by means of a heating device. Introduction of a silicon-containing reaction gas results in a deposition reaction on the hot particle surfaces. As a consequence, elemental silicon deposits on the silicon particles and the individual particles grow in diameter. The regular removal of grown-on particles and introduction of smaller silicon seed particles enables the process to be operated continuously, with all the advantages associated therewith. Silicon-containing feed gases which have been described are silicon-halogen compounds (e.g. chlorosilanes or bromosilanes), monosilane (SiH₄), and also mixtures of these gases with hydrogen.

Such deposition processes and apparatuses therefor are known, for example, from U.S. Pat. No. 4,786,477 A and U.S. Pat. No. 4,900,411 A.

U.S. Pat. No. 4,900,411 A discloses a process for obtaining high-purity polycrystalline silicon by deposition of silicon onto high-purity silicon particles from a silicon-containing gas such as silane, dichlorosilane, trichlorosilane or tribromosilane, using a reactor having a fluidized bed into which a reaction gas and also silicon seed particles are introduced through an inlet tube and into which microwaves are injected in order to heat the fluidized particles, so that polysilicon deposits thereon.

U.S. Pat. No. 4,786,477 A discloses an apparatus for carrying out the process, which has a reactor having a gas inlet tube for the reaction gas mixture at the lower end, a gas outlet tube at the upper end and also a feed tube for the silicon seed particles, wherein the reactor consisting of silica is located vertically on the middle line of a heat generator in which a shield against microwaves is installed in the middle part and which is connected to microwave generators via microwave guide tubes, with a gas distributor plate being arranged underneath the reactor and a gas barrier membrane being arranged within each microwave guide tube, and cooling channels are provided between the wall of the heat generator and the outer wall of the reactor and also in the gas distribution plate.

The silicon seed particles are heated by means of microwave radiation to a temperature of 600-1200° C.

U.S. Pat. No. 6,007,869 A discloses a process for preparing granular silicon having a chlorine contamination of less than 50 ppm by weight by deposition of elemental silicon on silicon particles in a fluidized-bed reactor having a heating zone and a reaction zone, where the silicon particles are fluidized by means of an inert, silicon-free carrier gas and heated by means of microwave energy in the heating zone and are exposed in the reaction zone to a reaction gas consisting of a silicon-containing feed gas and the carrier gas, wherein the average temperature of the reaction gas in the reaction zone while it flows through the fluidized silicon particles is less than 900° C. The reactor tube is made of metal, for example of stainless steel, and is lined on the inside with high-purity silica and shielded on the outside with insulation material having a low thermal conductivity, for example silica material.

U.S. Pat. No. 7,029,632 B2 discloses a fluidized-bed reactor consisting of:

a) a pressure-rated shell; b) an inner reactor tube made of a material which has a high transmission for heat radiation; c) an inlet (4) for silicon particles; d) an inlet device (6) for introducing a reaction gas which contains a gaseous silicon compound, with the inlet device being tubular and dividing the fluidized bed into a heating zone and a reaction zone located above the heating zone; e) a gas distribution device for introduction of a fluidizing gas into the heating zone; f) an outlet for unreacted reaction gas, fluidizing gas and also the gaseous or vaporized products of the reaction; g) an outlet for the products; h) a heating device; i) an energy supply for the heating device, wherein the heating device is a radiation source for heat radiation which is arranged outside the inner reactor tube and, without direct contact with this, in a ring-like manner around the heating zone and is configured in such a way that it heats the silicon particles in the heating zone by means of heat radiation in such a way that the reaction temperature is established in the reaction zone.

All components of the reactor which are in contact with product preferably consist of an inert material or are coated with such a material.

Particularly suitable materials for this purpose are silicon or silica.

The inner reactor tube must also in all cases have a high transmission for the heat radiation emitted by the heater selected. Thus, for example, in the case of fused silica of appropriate quality, the transmission for infrared radiation having wavelengths of less than 2.6 μm is greater than 90%. Thus, silica in combination with an infrared radiation heater (range from 0.7 to 2.5 μm), for example a radiator having an SiC surface whose maximum of the emitted radiation is at a wavelength of 2.1 μm, is particularly well suited.

In the deposition of high-purity polysilicon from a silicon-containing gas, a greater throughput can be obtained when the deposition temperature is selected to be as high as possible. An increase in the deposition temperature accelerates the deposition kinetics. The equilibrium yield with respect to silicon increases. If chlorosilanes are used as precursors, a lower chlorine value in the product due to a high deposition rate is expected. However, limits to increasing the temperature are imposed by the construction of the reactors.

In a fused silica reactor as in U.S. Pat. No. 4,786,477 A or U.S. Pat. No. 7,029,632 B2, the maximum permissible temperature is about 1150° C. If this temperature is exceeded locally in the long term, the glass becomes soft and deforms. It would therefore be desirable to find materials which have a higher heat resistance. At the same time, the material should have a transmittance of similar magnitude to that of fused silica or have a combination of a high emission and high thermal conductivity.

The materials should also be inert to chemical attack, especially by H₂, chlorosilane, HCl, and N₂, at high temperatures. Metals form silicides with chlorosilanes.

Free Silicon Reacts with Nitrogen to Form Silicon Nitride.

Nitrogen is frequently used as inert gas in the pressure-rated shell or in the heating space which bounds the reaction space (cf., for example, U.S. Pat. No. 4,900,411 A). If nitrogen is used in the pressure-rated shell, the reactor tube should be gastight in order to prevent nitrogen from the shell getting into the interior of the reactor tube.

Free Carbon Reacts with H₂ to Form Methane.

It is therefore proposed in the prior art that carbon-containing materials be coated or lined with silicon.

The fluidized bed can cause abrasion on the walls of reactor tubes. The reactor tube can also be subjected to high stresses, namely compressive stress due to the clamping of the tube, and thermal stresses caused by high temperature gradients in the axial and radial directions. The latter especially occurs when the fluidized bed is heated in a locally delimited area from the outside.

EP1337463B1 discloses a reactor for preparing high-purity, granular silicon by decomposition of a silicon-containing gas, wherein the reactor consists of a carbon fiber-reinforced material based on silicon carbide, where the thermally insulating regions at the bottom of the reactor and also at the top of the reactor consist of a carbon fiber-reinforced silicon carbide material having a low thermal conductivity while the remaining regions are made up of a carbon fiber-reinforced silicon carbide material having a high thermal conductivity.

A disadvantage is that such a reactor tube is not gastight with respect to nitrogen in the intermediate jacket. In addition, contamination of the granular silicon with carbon has to be expected.

U.S. Pat. No. 8,075,692 B2 describes a fluidized-bed reactor having a reactor tube made of a metal alloy and a demountable concentric sheath within the reactor tube, with the sheath being made of silicon carbide, silicon nitride, silicon, silica, a molybdenum alloy, molybdenum, graphite, a cobalt alloy or a nickel alloy or a coating comprising the materials mentioned. The sheath should withstand a temperature of at least 870° C., with the temperatures in the vicinity of the sheath being 700-900° C.

EP1984297 B1 discloses a fluidized-bed reactor for producing granular polycrystalline silicon, which comprises a) a reactor tube; b) a reactor sheath which surrounds the reactor tube; c) an inner zone formed in the reactor tube and an outer zone between the reactor sheath and the reactor tube, where a silicon particle bed is present in the inner zone and silicon deposition takes place there, while no silicon particle bed is present in the outer zone and no silicon deposition takes place there; d) a gas distributor device for introducing a gas into the silicon particle bed; e) an outlet for polycrystalline silicon particles and an outlet for reacted gas from the fluidized bed; f) an inert gas inlet for maintaining an essentially inert gas atmosphere in the outer zone; g) a pressure control device for measuring and controlling the inner zone pressure Pi or the outer zone pressure Po; h) a pressure difference control device for maintaining the value of Po−Pi within a range from 0 to 1 bar; where the inner zone pressure or the outer zone pressure is in the range from 1 to 15 bar.

The reactor tube preferably consists of an inorganic material which has a high heat resistance, e.g. quartz, silica, silicon nitride, boron nitride, silicon carbide, graphite, or amorphous carbon.

U.S. Pat. No. 8,431,032 B2 discloses a process for preparing polysilicon by means of a fluidized-bed reactor for preparing granular polysilicon, which comprises:

(i) a production step for the silicon particles in which the reaction gas is passed through the reaction gas supply device so that deposition of silicon takes place on the surface of the silicon particles which are in contact with the reaction gas, with silicon deposits being formed on the inner wall of the reactor tube surrounding the reaction zone,
(ii) a discharge step for silicon particles following the production step for the silicon particles; and
(iii) a step for removal of silicon deposits which follows the step for discharging silicon particles and in which the silicon deposits are removed by introduction of a corroding gas into the reaction zone so as to react with the silicon deposits to form gaseous silicon mixtures. The deposition temperature is 600-850° C. in the case of monosilane as feed gas and 900-1150° C. in the case of trichlorosilane. Tube materials mentioned are: quartz, silica, silicon nitride, silicon carbide, graphite, and amorphous carbon.

Owing to possible contamination of the product with carbon when silicon carbide, graphite or amorphous carbon is used, linings or coatings composed of silicon, silica, quartz or silicon nitride are proposed.

A disadvantage is that damage such as spalling or chipping through, to material failure can occur during cooling or as a result of irregularities in the process because of the different thermal expansion of the two materials.

In addition, such a reactor tube is not inert with respect to nitrogen in the intermediate jacket.

The corroding process described in U.S. Pat. No. 8,431,032 B2 enables the deposits on the wall of the reactor tube and on internals to be corroded away by means of a gas mixture. The corroding gas comprises, for example, HCl. Free silicon is corroded away by HCl. However, if free silicon is present in the tube itself, the reactor tube is also chemically attacked.

JP 63225514 A discloses a reactor tube composed of silicon carbide having a lining or coating of silicon for use in the fluidized-bed deposition of high-purity polysilicon from monosilane (SiH₄) at a deposition temperature of 550-1000° C. In a corroding process for removing wall deposits, the coating comprising silicon would be attacked.

The requirements which have to be met by a material for a reactor tube of a fluidized-bed reactor for the preparation of granular polycrystalline silicon are thus wide-ranging, and all the measures proposed in the prior art are unsatisfactory for various reasons. The problems described gave rise to the object of the invention, which was to overcome the problems of the prior art just described.

### SUMMARY OF THE INVENTION

These and other objects are achieved by a fluidized-bed reactor for preparing granular polycrystalline silicon, which comprises a reactor vessel (1), a reactor tube (2) and a reactor bottom (15) within the reactor vessel (1), where an intermediate jacket (3) is located between an outer wall of the reactor tube (2) and an inner wall of the reactor vessel (1), and further comprises a heating device (5), at least one bottom gas nozzle (9) for the introduction of fluidizing gas and also at least one secondary gas nozzle (10) for the introduction of reaction gas, a feed device (11), for supplying silicon seed particles, an offtake line (14) for granular polycrystalline silicon and also a facility for discharging reactor offgas (16), wherein a main element of the reactor tube (2) comprises at least 60% by weight of silicon carbide and has on its inside a CVD coating which has a layer thickness of at least 5 μm and consists to an extent of at least 99.995% by weight of silicon carbide.

The object is also achieved by a fluidized-bed reactor for preparing granular polycrystalline silicon, which comprises a reactor vessel (1), a reactor tube (2) and a reactor bottom (15) within the reactor vessel (1), where an intermediate jacket (3) is located between an outer wall of the reactor tube (2) and an inner wall of the reactor vessel (1), and further comprises a heating device (5), at least one bottom gas nozzle (9) for the introduction of fluidizing gas and also at least one secondary gas nozzle (10) for the introduction of reaction gas, a feed device (11), for supplying silicon seed particles, an offtake line (14) for granular polycrystalline silicon and also a facility for discharging reactor offgas (16), wherein a main element of the reactor tube (2) consists of sapphire glass comprising at least 99.99% by weight of α-Al₂O₃.

### BRIEF DESCRIPTION OF THE DRAWINGS

FIG. 1 shows the schematic structure of a fluidized-bed reactor.

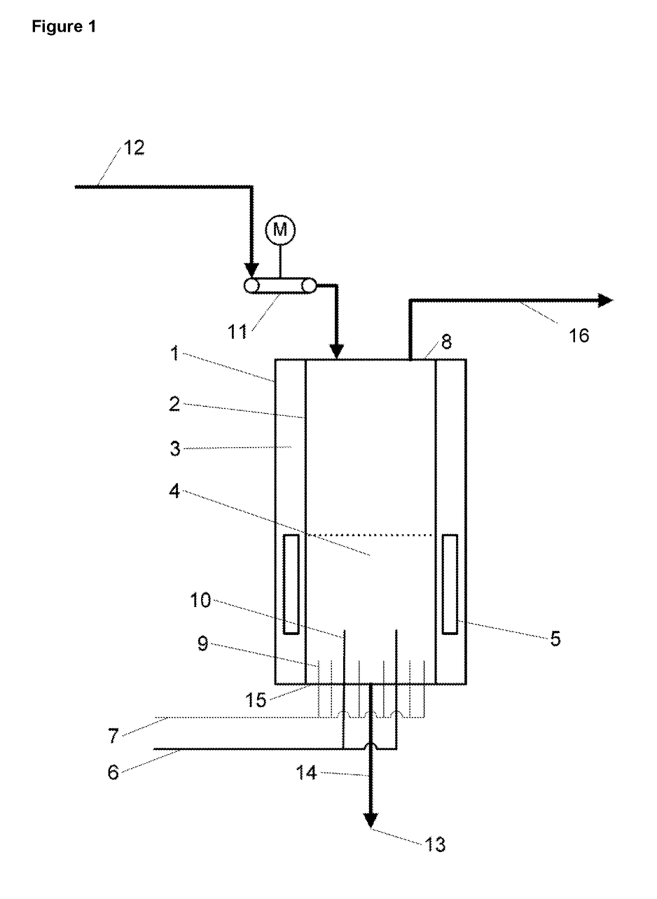

### DETAILED DESCRIPTION OF THE PREFERRED EMBODIMENTS

The fluidized-bed reactor of the invention provides for the use of silicon carbide for the main element of the reactor tube and also for the coating of the reactor tube. Silicon carbide (SiC) has a high thermal conductivity of from 20 to 150 W/m-K at 1000° C. and emission of 80 to 90%.

The CVD coating composed of SiC preferably has a layer thickness of from 30 to 500 μm, particularly preferably a layer thickness of from 50 to 200 μm. Preference is given both to the tube inside and the tube outside being coated. being coated.

The main element preferably consists of sintered SiC (SSiC).

SSiC is heat resistant up to about 1800-1900° C. and even without further treatment is gastight. During manufacture, compounds containing electron acceptors (e.g. boron) are usually added as sintering aids. The proportion of SiC in the SSiC main element is in this case more than 90% by weight.

The main element can also consist of nitride-bonded SiC. This material is heat resistant up to about 1500° C. Main constituents are SiC (65-90% by weight) and less than 6% by weight of metallic impurities or sintering aids. Further constituents are Si₃N₄ and free silicon.

Nitride-bonded SiC is not gastight without further treatment. However gastightness is brought about by the CVD coating.

The main element can also consist of recrystallized SiC (RSiC). RSiC is heat resistant up to about 1800-2000° C. and has a high purity of greater than 99% by weight of SiC. However, the material is open-pored and thus not gastight without further treatment.

One possible treatment for achieving gastightness is infiltration with liquid silicon to fill the pores. This lowers the maximum use temperature to about 1400° C. The subsequent CVD coating ensures chemical inertness and the required surface purity. The CVD coating would be frail if no wall deposits were to be corroded away and high-purity polysilicon were used for infiltration.

As an alternative, gastightness can be ensured by an SiC-CVD coating having a layer thickness of from 200 to 800 μm.

The main element can also consist of reaction-bonded SiC (RBSiC or SiSiC). This comprises from 65 to 95% by weight of SiC and less than 1% by weight of metallic impurities. Further constituents are free silicon and free carbon. The material is usable up to 1400° C., but because of an excess of silicon is not inert with respect to a corroding atmosphere. If C fibers are used for mechanical stabilization and control of the thermal conduction properties of the material, free carbon is possibly present at the surface. This is susceptible to methanation and thereby impairs the gastightness. However, a CVD coating having a layer thickness of at least 5 μm and comprising at least 99.995% by weight of SiC ensures the chemical inertness and the surface purity of the material.

The preferred materials are thus usable up to a temperature of at least 1400° C., which represents an advantage over, for example, the silicon nitride proposed in the prior art, which is stable only up to about 1250° C.

The inventive element and coating have essentially the same coefficients of thermal expansion. On the other hand, in the case of coating of an SiC main element with Si₃N₄, the coating would spall.

A reactor tube composed of high-purity sapphire glass (α-Al₂O₃) having a purity of at least 99.99% by weight is usable up to 1900° C. and has similar transition properties to glass, a high abrasion resistance and is chemically resistant to all reaction gases. Furthermore, the material can, owing to a virtually identical coefficient of thermal expansion (4.6.10⁻⁶ K⁻¹ at 1000° C.), be provided with an SiC-CVD coating, which is preferred.

The reactor tube preferably has a CVD coating comprising at least 99.995% by weight of SiC and having a layer thickness of at least 5 μm at least on its inside. The CVD coating comprising SiC preferably has a layer thickness of 30-500 μm, more preferably from 50 to 200 μm. As an alternative, both the tube inside and the tube outside are coated.

In both the apparatuses of the invention, the intermediate jacket preferably comprises an insulation material and is filled with an inert gas or is flushed with an inert gas. Preference is given to using nitrogen as an inert gas.

The pressure in the intermediate jacket is preferably greater than in the reaction space.

The high purity of the SiC coating of at least 99.995% by weight of SiC ensures that dopants (electron donors and acceptors, for example B, Al, As, P), metals, carbon, oxygen or chemical compounds of these substances are present only in low concentrations in the regions close to the surface of the reactor tube, so that the individual elements cannot get into the fluidized bed in an appreciable amount either by diffusion or as a result of abrasion.

No free silicon and no free carbon are present at the surface. Inertness with respect to H₂, chlorosilane, HCl and N₂ is ensured thereby.

Contamination of the granular polycrystalline silicon with carbon is prevented by a high-purity CVD coating being used in the SiC reactor. Appeliable amounts of carbon would transfer from pure SiC only on contact with liquid silicon.

The invention also provides a process for preparing granular polycrystalline silicon in a fluidized-bed reactor as described above having a new type of reactor tube, which comprises fluidization of silicon seed particles by means of a gas flow in a fluidized bed which is heated by means of a heating device, wherein polycrystalline silicon is deposited on the hot silicon seed particle surfaces by introduction of a silicon-containing reaction gas, resulting in formation of the granular polycrystalline silicon.

The granular polycrystalline silicon formed is preferably discharged from the fluidized-bed reactor. Silicon deposits on walls of the reactor tube and other reactor components are then preferably removed by introduction of a corroding gas into the reaction zone.

Preference is likewise given to continuously introducing corroding gas during deposition of polycrystalline silicone on the hot silicon seed particle surfaces in order to avoid silicon deposits on walls of the reactor tube and other reactor components. The introduction of the corroding gas is preferably effected locally in the free board zone, which refers to the gas space above the fluidized bed.

The deposits on the wall can thus be corroded away cyclically and alternated with the deposition process. As an alternative, corroding gas can be continuously introduced locally during deposition operation in order to avoid formation of wall deposits.

The process is preferably operated continuously by discharging particles which have grown in diameter as a result of deposition from the reactor and introducing fresh silicon seed particles.

Preference is given to using trichlorosilane as silicon-containing reaction gas. The temperature of the fluidized bed in the reaction region is in this case more than 900° C. and preferably more than 1000° C.

The temperature of the fluidized bed is preferably at least 1100° C., more preferably at least 1150° C. and most preferably at least 1200° C. The temperature of the fluidized bed in the reaction region can also be 1300-1400° C.

The temperature of the fluidized bed in the reaction region is most preferably from 1150° C. to 1250° C. A maximum in the deposition rate is achieved in this temperature range, and decreases again at even higher temperatures.

Preference is likewise given to using monosilane as silicon-containing reaction gas. The temperature of the fluidized bed in the reaction region in this case is preferably 550-850° C.

Furthermore, preference is given to using dichlorosilane as silicon-containing reaction gas. The temperature of the fluidized bed in the reaction region in this case is preferably 600-1000° C.

The fluidizing gas is preferably hydrogen.

The reaction gas is injected into the fluidized bed via one or more nozzles.

The local gas velocities at the exit of the nozzles are preferably from 0.5 to 200 m/s.

The concentration of the silicon-containing reaction gas is preferably from 5 mol % to 50 mol %, more preferably from 15 mol % to 40 mol %, based on the total amount of gas flowing through the fluidized bed.

The concentration of the silicon-containing reaction gas in the reaction gas nozzles is preferably from 20 mol % to 80 mol %, more preferably from 30 mol % to 60 mol %, based on the total amount of gas flowing through the reaction gas nozzles. Preference is given to using trichlorosilane as a silicon-containing reaction gas.

The reactor pressure is in the range from 0 to 7 bar gauge, preferably in the range from 0.5 to 4.5 bar gauge.

In the case of a reactor having a diameter of, for example, 400 mm, the mass flow of silicon-containing reaction gas is preferably from 200 to 600 kg/h. The hydrogen volume flow is preferably from 100 to 300 standard m³/h. In the case of larger reactors, greater amounts of silicon-containing reaction gas and H₂ are preferred.

It will be clear to a person skilled in the art that some process parameters are ideally selected as a function of the reactor size. For this reason, operating data normalized to the cross-sectional area of the reactor at which the process of the invention is preferably operated are specified below.

The specific mass flow of silicon-containing reaction gas is preferably 1600-6500 kg/(h*m²).

The specific volume flow of hydrogen is preferably 800-4000 standard m³/(h*m²).

The specific bed weight is preferably 700-2000 kg/m².

The specific silicon seed particle introduction rate is preferably 7-25 kg/(h*m²).

The specific reactor heating power is preferably 800-3000 kW/m².

The residence time of the reaction gas in the fluidized bed is preferably from 0.1 to 10 s, particularly preferably from 0.2 to 5 s.

The features indicated in respect of the embodiments of the process of the invention described here can be carried over analogously to the apparatus of the invention. Conversely, the features indicated in respect of the embodiments of the apparatus of the invention indicated above can be carried over analogously to the process of the invention. These and other features of the embodiments of the invention are explained in the description of the figures and in the claims. The individual features can be realized either separately or in combination as embodiments of the invention. Furthermore, they can describe advantageous embodiments which are independently capable of protection.

### LIST OF REFERENCE NUMERALS

1 Reactor vessel
2 Reactor tube
3 Intermediate jacket
4 Fluidized bed
5 Heating device
6 Reaction gas
7 Fluidizing gas
8 Top of the reactor
9 Bottom gas nozzle
10 Secondary gas nozzle
11 Seed introduction facility
12 Seed
13 Granular polycrystalline silicon
14 Offtake line
15 Bottom of the reactor
16 Reactor offgas

The fluidized-bed reactor consists of a reactor vessel 1 into which a reactor tube 2 is inserted.

Between the inner wall of the reactor vessel 1 and the outer wall of the reactor tube 2, there is an intermediate jacket 3.

The intermediate jacket 3 comprises insulation material and is filled with an inert gas or is flushed with an inert gas.

The pressure in the intermediate jacket 3 is greater than in the reaction space bounded by the walls of the reactor tube 2.

In the interior of the reactor tube 2, there is the fluidized bed 4 of granular polysilicon. The gas space above the fluidized bed (above the broken line) is usually referred to as “free board zone”.

The fluidized bed 4 is heated by means of a heating device 5.

The fluidizing gas 7 and the reaction gas mixture 6 are introduced as gases into the reactor.

The introduction of gas is effected in a targeted manner via nozzles.

The fluidizing gas 7 is introduced via bottom gas nozzles 9 and the reaction gas mixture is introduced via secondary gas nozzles (reaction gas nozzles) 10.

The height of the secondary gas nozzles 10 can differ from the height of the bottom gas nozzles 9.

A bubble-forming fluidized bed 4 with additional vertical secondary gas injection is formed in the reactor as a result of the arrangement of the nozzles.

The top 8 of the reactor can have a larger cross section than the fluidized bed 4.

Seed 12 is introduced at the top 8 of the reactor by means of a seed introduction facility 11 with motor M.

The granular polycrystalline silicon 13 is taken off via an offtake line 14 at the bottom 15 of the reactor.

At the top 8 of the reactor, the reactor offgas 16 is taken off.

### EXAMPLES AND COMPARATIVE EXAMPLES

### Deposition

High-purity granular polysilicon is deposited from trichlorosilane in a fluidized-bed reactor. Hydrogen is used as fluidizing gas, and deposition takes place at a pressure of 3 bar (abs) in a reactor tube having an internal diameter of 500 mm. Product is continuously taken off and the introduction of seed is regulated so that the Sauter diameter of the product is 1000±50 μm. The intermediate jacket is flushed with nitrogen. The residence time of the reaction gas in the fluidized bed is 0.5 s. A total of 800 kg/h of gas is introduced, with 17.5 mol % thereof being trichlorosilane and the remainder consisting of hydrogen.

### Example 1

When the reactor tube consists of SSiC having an SiC content of 98% by weight and has a 150 μm thick CVD coating, a fluidized bed temperature of 1200° C. can be achieved. The reaction gas reacts to equilibrium. Thus, 38.9 kg/h of silicon can be deposited. A yield per unit area of 198 kg h⁻¹ m⁻² of silicon and a chlorine content of 14 ppmw in the product are obtained.

### Comparative Example 1

In contrast, when the reactor tube consists of fused silica, a fluidized bed temperature of only 980° C. can be achieved since otherwise a temperature of 1150° C. is exceeded in the long term at the heated reactor tube outside. 29.8 kg/h of silicon can be deposited (90% of the equilibrium yield).

A yield per unit area of 152 kg h⁻¹ m⁻² of silicon and a chlorine content of 26 ppmw in the product are obtained in this way.

The differences in the average values of the dopant, carbon and metal contents in the product between the two processes are less than the statistical scatter.

### Corroding Process

A corroding process is operated alternately with the deposition process of Example 1 or Comparative example 1.

Here, the bed is lowered and 30 kg/h of HCl are introduced instead of trichlorosilane.

The reaction temperature is selected similarly to that in the deposition process in order to avoid thermal stresses between reactor tube and wall deposits.

### Example 2

When the reactor tube consists of SSiC having an SiC content of 98% by weight and has a high-purity SiC coating having a thickness of 150 μm, the reactor tube is not chemically attacked and can be used further without restriction after the corroding process.

### Comparative Example 2

However, when the reactor tube consists of silicon or SiSiC without surface treatment, the reactor tube is also corroded at the same time as the wall deposits.

This leads to impairment of the mechanical stability of the reactor tube through to failure of the component. The consequence is exchange of material between the intermediate jacket and the reaction space.

During the corroding process, hydrogen can react with a carbon-containing heater and the nitrogen used as inert gas to form the toxic product HCN.

During the deposition process, the product comes into contact with contaminants from the heating space.

Nitrogen is also incorporated into the product.

Chlorosilanes react on the hot heater surface to form silicon nitride which forms soft growths there.

Contact with hot, conductive granular material can in the extreme case also lead to electrical grounding of the heater.

The reactor has to be taken out of operation while corroding is still occurring. The reactor tube is no longer usable for further runs.

The above description of illustrative embodiments should be interpreted as being by way of example. The associated disclosure firstly helps a person skilled in the art to understand the present invention and the associated advantages and, secondly, encompasses obvious, to a person skilled in the art, alterations and modifications of the structures and processes described. All such alterations and modifications and also equivalents should therefore be considered to come within the scope of protection of the claims.

1.-19. (canceled)

20. A fluidized-bed reactor for preparing granular polycrystalline silicon, comprising:
a reactor vessel, a reactor tube and a reactor bottom within the reactor vessel, an intermediate jacket located between an outer wall of the reactor tube and an inner wall of the reactor vessel, a heating device, at least one bottom gas nozzle for the introduction of fluidizing gas and at least one secondary gas nozzle for the introduction of reaction gas, a silicon seed particle feed, a granular polycrystalline silicon offtake line and a reactor offgas discharge, wherein a main element of the reactor tube is a durable main element comprising sapphire glass comprising at least 99.99% by weight of α-Al₂O₃, or comprises at least 60% by weight of silicon carbide and has at least on its inside, a CVD coating which has a layer thickness of at least 5 μm and comprises of at least 99.995% by weight of silicon carbide.

21. The fluidized-bed reactor of claim 20, wherein an outside of the reactor tube has a CVD coating which has a layer thickness of at least 5 μm and is at least 99.995% by weight of silicon carbide.

22. The fluidized-bed reactor as claimed in claim 21, wherein the main element of the reactor tube (2) consists of sintered silicon carbide, nitride-bonded silicon carbide, recrystallized silicon carbide or reaction-bonded silicon carbide.

23. The fluidized-bed reactor of claim 20, wherein the CVD coating has a layer thickness of 30-500 μm.

24. The fluidized-bed reactor of claim 23, wherein the CVD coating has a layer thickness of 50-200 μm.

25. The fluidized-bed reactor for preparing granular polycrystalline silicon, wherein a main element of the reactor tube (2) consists of sapphire glass comprising at least 99.99% by weight of α-Al₂O₃.

26. The fluidized-bed reactor of claim 25, further comprises a CVD coating which has a layer thickness of at least 5 μm, and comprises at least 99.995% by weight of silicon carbide at least on an inside of the main element of the reactor tube.

27. The fluidized-bed reactor of claim 26, wherein an outside of the reactor tube additionally comprises a CVD coating which has a layer thickness of at least 5 μm and comprises at least 99.995% by weight of silicon carbide.

28. The fluidized-bed reactor of claim 26, wherein the inside CVD coating has a layer thickness of 30-500 μm.

29. The fluidized-bed reactor of claim 27, wherein the inside CVD coating has a layer thickness of 30-500 μm.

30. The fluidized-bed reactor of claim 28, wherein the inside CVD coating has a layer thickness of 50-200 μm.

31. The fluidized-bed reactor of claim 20, wherein the intermediate jacket (3) comprises an insulation material and is filled with or is flushed with an inert gas.

32. In a process for preparing granular polycrystalline silicon which is carried out in a fluidized-bed reactor and comprises fluidizing silicon seed particles by means of a gas flow in a fluidized bed heated by means of a heating device, wherein polycrystalline silicon is deposited on the hot silicon seed particle surfaces by introducing of a silicon-containing reaction gas, resulting in formation of the granular polycrystalline silicon, the improvement comprising conducting the process in a reactor of claim 20.

33. The process of claim 32, wherein the granular polycrystalline silicon formed is discharged from the fluidized-bed reactor, further comprising removing silicon deposits on walls of the reactor tube and other reactor components by introducing a corroding gas into the reaction zone.

34. The process of claim 32, comprising continuously introducing a corroding gas during deposition of polycrystalline silicon on hot silicon seed particle surfaces to avoid silicon deposits on walls of the reactor tube and other reactor components.

35. The process of claim 34, comprising introducing the corroding gas locally into a gas space above the fluidized bed.

36. The process of claim 32, wherein trichlorosilane is used as a silicon-containing gas and the fluidized bed is heated to a temperature of more than 900° C.

37. The process of claim 36, wherein the fluidized bed is heated to a temperature of at least 1100° C.

38. The process of claim 32, wherein monosilane is used as a silicon-containing gas, and the fluidized bed is heated to a temperature of 550-850° C.

39. A process as claimed in any of claim 32, wherein dichlorosilane is used as silicon-containing gas and the fluidized bed is heated to a temperature of 600-1000° C.
